(19) United States
(12) Patent Application Publication
(10) Pub. No.: US 2026/0321041 A1
(43) Pub. Date: Oct. 15, 2026

(54) UTILIZING A MASK-AWARE VISION-LANGUAGE CAPTIONING MODEL TO GENERATE IMAGE CAPTIONS

(71) Applicant: Adobe Inc., San Jose, CA (US)

(72) Inventors: Hang Hua, Rochester, NY (US); Qing Liu, Santa Clara, CA (US); Lingzhi Zhang, Philadelphia, PA (US); Jing Shi, Rochester, NY (US); Soo Ye Kim, Daejeon (KR); Zhifei Zhang, San Jose, CA (US); Yilin Wang, San Jose, CA (US); Jianming Zhang, Campbell, CA (US); Zhe Lin, Fremont, CA (US)

(21) Appl. No.: 19/176,721

(22) Filed: Apr. 11, 2025

(51) Int. Cl. G06V 20/70; G06T 3/4046; G06T 3/4053; G06V 10/25

(52) U.S. Cl. CPC G06V 20/70; G06T 3/4046; G06T 3/4053; G06V 10/25

(57) ABSTRACT

The present disclosure relates to systems, non-transitory computer-readable media, and methods for generating captions for a digital image at multiple granularity levels utilizing a mask-aware vision-language captioning model. In particular, the disclosed systems receive, by at least one processing device, a text prompt and a digital image with a binary mask indicating a region of interest in the digital image. Additionally, the disclosed systems generate, utilizing a mask-aware vision-language captioning model, an image caption for the digital image describing the region of interest based on the text prompt.

### BACKGROUND

Recent years have seen significant improvements in machine learning models, such as vision-language models, that perform multimodal tasks. For example, conventional vision-language model systems are capable of captioning images and videos, performing visual question answering, and performing cross-modal retrieval. Despite these recent improvements, conventional vision-language models continue to struggle with detailed image content perception of regions within digital images, for example, when captioning images. Indeed, conventional vision-language models have a number of drawbacks that negatively impact accuracy when generating image captions for digital images based on detailed image content within the digital image.

### SUMMARY

Embodiments of the present disclosure provide benefits and/or solve one or more of the foregoing or other problems in the art with systems, non-transitory computer-readable media, and methods capable of generating captions for a digital image at multiple granularity levels utilizing a mask-aware vision-language captioning model. In particular, the disclosed systems utilize a novel vision-language model (e.g., the mask-aware vision-language captioning model) with enhanced capabilities for generating multi-grained image captions based on a mask-referred region of an image. For instance, the novel vision-language model includes a mask-aware image encoder for mask-referring and a high-resolution encoder for fine-grained perception of compositional information of images. Indeed, in some embodiments, the disclosed systems perform multi-grained image captioning including attribute-aware regional captioning, regional dense captioning, and comprehensive global image captioning.

Additional features and advantages of one or more embodiments of the present disclosure are outlined in the description which follows, and in part are determined from the description, or are learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates an example system environment in which a mask-aware regional captioning system operates in accordance with one or more embodiments.

FIG. 2 illustrates an overview diagram of a mask-aware regional captioning system generating image captions at varying granularity levels utilizing a mask-aware vision-language captioning model in accordance with one or more embodiments.

FIG. 3 illustrates a diagram of a mask-aware regional captioning system generating a mask-aware feature map in accordance with one or more embodiments.

FIG. 4 illustrates a diagram of a mask-aware regional captioning system generating a fused feature map in accordance with one or more embodiments.

FIG. 5 illustrates a diagram of a mask-aware regional captioning system generating image captions at varying levels of granularity in accordance with one or more embodiments.

FIG. 6 illustrates an example schematic diagram of a mask-aware regional captioning system in accordance with one or more embodiments.

FIG. 7 illustrates a flowchart of an example series of acts for generating an image caption describing a region of interest in a digital image utilizing a mask-aware vision-language captioning model in accordance with one or more embodiments.

FIG. 8 illustrates a flowchart of an example series of acts for generating an image caption from a mask-aware feature map utilizing a mask-aware vision-language captioning model in accordance with one or more embodiments.

FIG. 9 illustrates a flowchart of an example series of acts for generating a caption for an image from a mask-aware feature map and high-resolution feature maps in accordance with one or more embodiments.

FIG. 10 illustrates a block diagram of an example computing device for implementing one or more embodiments of the present disclosure.

### DETAILED DESCRIPTION

This disclosure describes one or more embodiments of a mask-aware regional captioning system that generates captions for a digital image at any of multiple granularity levels utilizing a mask-aware vision-language captioning model. In particular, the mask-aware regional captioning system utilizes a novel vision-language model (e.g., the mask-aware vision-language captioning model) with enhanced capabilities for generating multi-grained image captions based on a region of interest indicated by a mask of an image. Indeed, in one or more implementations, the mask-aware regional captioning system generates attribute-aware regional captions, regional dense captions, and/or comprehensive global image captions.

In one or more embodiments, the mask-aware regional captioning system utilizes a mask-aware encoder of the mask-aware vision-language captioning model to generate a mask-aware feature map. Specifically, the mask-aware regional captioning system utilizes an image encoder neural network to generate mask embeddings from a binary mask indicating a region of interest of a digital image. Further, in one or more implementations, the mask-aware regional captioning system separately generates patch embeddings from a low-resolution version of the digital image utilizing the image encoder neural network. In these or other embodiments, the mask-aware regional captioning system combines the mask embeddings and the patch embeddings into a combined input sequence for use with the mask-aware encoder. Moreover, in these or other embodiments, the mask-aware regional captioning system utilizes the mask-aware encoder to generate the mask-aware feature map based on the combined input sequence.

Furthermore, in some embodiments, the mask-aware regional captioning system generates a fused feature map utilizing the mask-aware vision-language captioning model. In particular, the mask-aware regional captioning system generates two high-resolution feature maps, one from each of two high-resolution encoders of the mask-aware vision-language captioning model, based on the high-resolution version of the digital image. Additionally, in some implementations, the mask-aware regional captioning system fuses the mask-aware feature map and the two high-resolution feature maps into a fused feature map utilizing a channel-wise fusion layer of the mask-aware vision-language captioning model.

Further, in one or more embodiments, the mask-aware regional captioning system generates image captions at varying granularity levels utilizing a large language model of the mask-aware vision-language captioning model. Specifically, the mask-aware regional captioning system utilizes an adapter of the mask-aware vision-language captioning model to map the fused feature map into the embedding space of the large language model. Based on a text prompt received via a client device, the mask-aware regional captioning system utilizes the large language model to generate image captions for the image. For instance, the mask-aware regional captioning system generates attribute-aware regional captions, regional dense captions, and/or comprehensive global image captions.

Although conventional systems generate captions for images, such systems have a number of problems in relation to accuracy. For instance, conventional systems inaccurately perceive fine-grained regional composition information of digital images. In particular, conventional systems inaccurately align segmentation masks with corresponding semantics and imprecisely describe the compositional aspects of the mask-referred regions. Some conventional systems have attempted to improve accuracy by processing regions specified by bounding boxes to leverage visual instruction tuning with object-level spatial features. Such methods, however, are limited by the fact that bounding boxes are inadequate for providing precise references to image regions resulting in inaccurate and/or overly broad image captions. Another approach of conventional systems includes enabling vision-language models to recognize arbitrary visual prompts and focus on the referred regions by incorporating overlaid images and visual prompts as input. Such freeform overlaid visual prompts, however, confuse vision-language models because the models interpret the visual prompt as an integral part of the image's semantic content. Again, this limitation results in inaccurate and/or overly broad image captions.

As suggested by the foregoing, embodiments of the mask-aware regional captioning system provide a variety of improvements relative to conventional systems. For example, by utilizing a mask-aware vision-language captioning model to accurately recognize arbitrary masks as referential inputs and processing high-resolution images for compositional image captioning at different granularity levels, the mask-aware regional captioning system improves accuracy relative to conventional systems. Specifically, in one or more implementations, the mask-aware regional captioning system accurately recognizes arbitrary masks as referential inputs by generating a mask-aware feature map utilizing the mask-aware vision-language captioning model. In particular, the mask-aware regional captioning system separately generates mask embeddings from a binary mask indicating a region of interest of a digital image and patch embeddings from a low-resolution version of the digital image. Moreover, in some embodiments, the mask-aware regional captioning system combines these embeddings and generates a mask-aware feature map for use in generating the image captions.

Furthermore, in some implementations, the mask-aware regional captioning system processes high-resolution images by utilizing multiple high-resolution encoders to encode fine-grained features of the digital image into multiple high-resolution feature maps. Additionally, in one or more embodiments, the mask-aware regional captioning system generates accurate image captions by generating a fused feature map from the mask-aware feature map and the high-resolution feature maps and mapping the fused feature map to an embedding space of a large language model of the mask-aware vision-language captioning model. In these or other embodiments, the mask-aware regional captioning system, utilizes the large language model to generate the image captions at varying levels of granularity (e.g., by generating attribute-aware regional captions, regional dense captions, and/or a comprehensive global image captions).

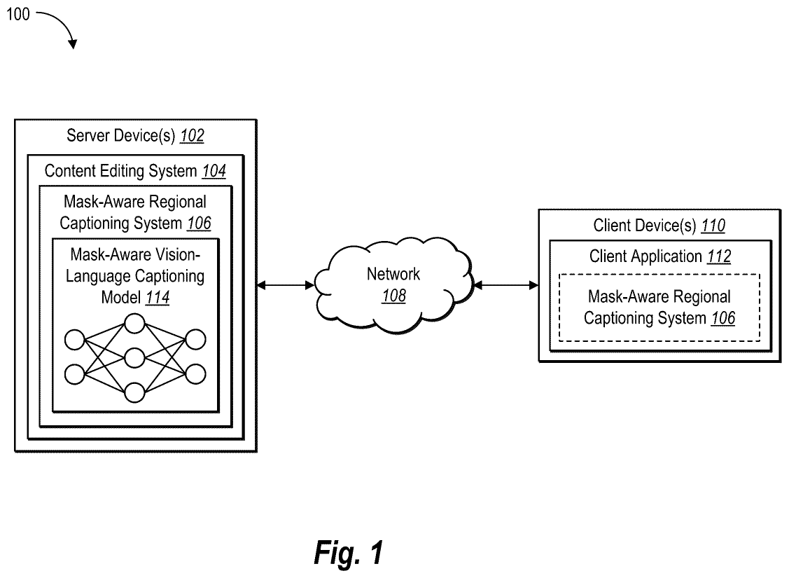

Additional detail regarding the mask-aware regional captioning system 106 will now be provided with reference to the figures. For instance, FIG. 1 illustrates a schematic diagram of a system environment 100 in which a mask-aware regional captioning system 106 operates. As illustrated in FIG. 1, the system environment 100 includes a server device(s) 102, a network 108, and a client device(s) 110. Although the system environment 100 of FIG. 1 is depicted as having a particular number of components, the system environment 100 is capable of having any number of additional or alternative components (e.g., any number of server devices, client devices, or other components in communication with the mask-aware regional captioning system 106 via the network 108). Similarly, although FIG. 1 illustrates a particular arrangement of the server device(s) 102, the network 108, and the client device(s) 110, various additional arrangements are possible.

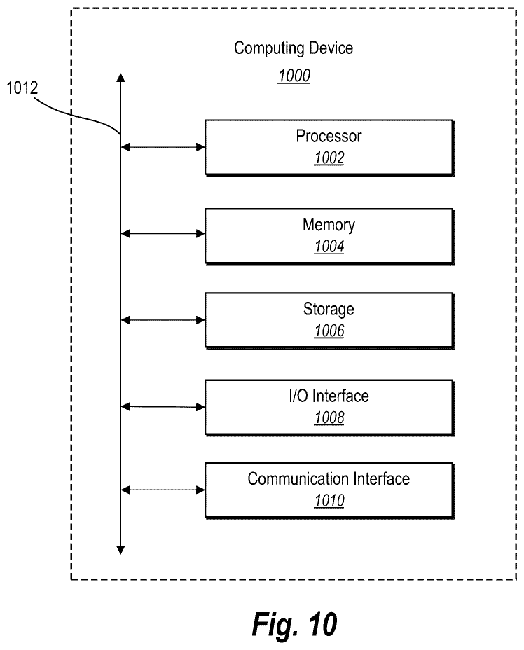

The server device(s) 102, the network 108, and the client device(s) 110 are communicatively coupled with each other either directly or indirectly (e.g., through the network 108 discussed in greater detail below in relation to FIG. 10). Moreover, the server device(s) 102 and the client device(s) 110 include one or more of a variety of computing devices (including one or more computing devices as discussed in greater detail with relation to FIG. 10).

As mentioned above, the system environment 100 includes the server device(s) 102. In one or more embodiments, the server device(s) 102 generates, stores, receives, and/or transmits data including notifications, models, and digital images. In one or more embodiments, the server device(s) 102 comprises a data server. In some implementations, the server device(s) 102 comprises a communication server, a content editing server, or a web-hosting server.

As shown, the server device(s) 102 includes a content editing system 104. In one or more embodiments, the content editing system 104 provides functionality by which a client device (e.g., the client device(s) 110) views, generates, stores, and/or edits digital images and/or digital documents. For example, in some instances, a client device sends a digital image to the content editing system 104 hosted on the server device(s) 102 via the network 108. The content editing system 104 then provides options usable by the client device to caption the digital image, edit or store the digital image and/or image captions, and subsequently search for, access, and view the digital image and image captions. To illustrate, the content editing system 104 provides one or more options that are usable by the client device to train one or more mask-aware vision-language captioning models and/or generate content therefrom.

As further shown, the server device(s) 102 also include the mask-aware regional captioning system 106 with a mask-aware vision-language captioning model (e.g., the mask-aware vision-language captioning model(s) 114) for generating content such as image captions in the content editing system 104. In one or more embodiments, the mask-aware regional captioning system 106 generates receives and/or accesses a text prompt, a digital image, and a binary mask of the digital image. In particular, as will be explained below, the mask-aware regional captioning system 106 uses the text prompt, digital image, and binary mask with the mask-aware vision-language captioning model(s) 114 to generate image captions for the digital image. For instance, the mask-aware regional captioning system 106 extracts regional information/features from the digital image and binary mask to generate image captions in response to the text prompt utilizing the mask-aware vision-language captioning model(s) 114.

As illustrated in FIG. 1, the mask-aware regional captioning system 106 includes a mask-aware vision-language captioning model(s) 114. Indeed, in these or other embodiments, the mask-aware regional captioning system 106 accesses the mask-aware vision-language captioning model(s) 114 to extract features of the digital image and binary mask generate outputs such as image captions for the digital image. In some cases, the mask-aware vision-language captioning model(s) 114 is external to the mask-aware regional captioning system 106, but the mask-aware regional captioning system 106 nevertheless accesses and utilizes the mask-aware vision-language captioning model(s) 114 via one or more plugins, APIs, or other network-based access protocols.

In some embodiments, a mask-aware vision-language captioning model includes or refers to a specialized type of machine learning model, and more particularly, a specialized type of neural network. Specifically, a mask-aware vision-language captioning model processes and understands both visual and textual information of a digital image with reference to a region of interest indicated by a binary mask of the digital image to perform multimodal tasks. For example, a mask-aware vision-language captioning model includes and utilizes various components to extract features from the digital image and binary mask and generate image captions for the digital image. To illustrate, a mask-aware vision-language captioning model includes one or more mask encoding components, image encoding components, fusion mechanisms, and large language models for extracting features from the digital image and binary mask and generating image captions.

Along these lines, a neural network refers to a machine learning model that is trained and/or tuned based on inputs to generate digital content such as text and images, and to determine classifications, scores, or approximate unknown functions. For instance, a neural network includes a model of interconnected artificial neurons (e.g., organized in layers) that communicate and learn to approximate complex functions and generate outputs (e.g., information flow patterns) based on a plurality of inputs provided to the neural network. In some cases, a neural network refers to a computer process that implements deep learning techniques to model high-level abstractions in data. In some embodiments, a neural network includes various layers such as an input layer, one or more hidden layers, and an output layer that each perform tasks for processing data. For example, a neural network includes a deep neural network, a convolutional neural network, a recurrent neural network (e.g., an LSTM), a graph neural network, a transformer neural network, a diffusion neural network, a multi-scale attention network, or a large language model.

In one or more embodiments, the client device(s) 110 includes a computing device that accesses, edits, segments, modifies, stores, and/or provides, for display, digital content such as digital images with artificial intelligence generated content such as image captions. For instance, in some embodiments, the client device(s) 110 includes a smartphone, a tablet, a desktop computer, a laptop computer, a head-mounted-display device, or another electronic device, including those explained below with reference to FIG. 10. In some instances, the client device(s) 110 includes one or more applications (e.g., a client application 112) that access, edit, segment, modify, store, and/or provide, for display, digital content such as digital images with artificial intelligence generated content such as image captions. For example, in one or more embodiments, the client application 112 includes a software application installed on the client device(s) 110. Additionally, or alternatively, the client application 112 includes a web browser or other application that accesses a software application hosted on the server device(s) 102 (and supported by the content editing system 104).

Additionally, as shown in FIG. 1, the system environment 100 includes the network 108. The network 108 enables communication between components of the system environment 100. In one or more embodiments, the network 108 may include the Internet or World Wide Web. Additionally, the network 108 optionally include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server device(s) 102 and the client device(s) 110 communicates via the network using one or more communication platforms and technologies suitable for transporting data and/or communication signals, including any known communication technologies, devices, media, and protocols supportive of data communications, examples of which are described with reference to FIG. 10.

To provide an example implementation, in some embodiments, the mask-aware regional captioning system 106 on the server device(s) 102 supports the mask-aware regional captioning system 106 on the client device(s) 110. For instance, in some cases, the mask-aware regional captioning system 106 on the server device(s) 102 extracts features from the digital image and binary mask for the mask-aware vision-language captioning model(s) 114. The mask-aware regional captioning system 106 then, via the server device(s) 102, provides the mask-aware vision-language captioning model(s) 114 to the client device(s) 110. In other words, the client device(s) 110 obtains (e.g., downloads) the mask-aware vision-language captioning model(s) 114 from the server device(s) 102. Once downloaded, the mask-aware regional captioning system 106 on the client device(s) 110 uses the mask-aware vision-language captioning model(s) 114 to generate image captions independent of the server device(s) 102. In some implementations, the mask-aware regional captioning system 106 generates or learns parameters for the mask-aware vision-language captioning model(s) 114 on the client device(s) 110.

In alternative implementations, the mask-aware regional captioning system 106 includes a web hosting application that allows the client device(s) 110 to interact with content and services hosted on the server device(s) 102. To illustrate, in one or more implementations, the client device(s) 110 accesses a software application supported by the server device(s) 102. The client device(s) 110 provides input to the server device(s) 102, such as a training data and/or digital images for use as input and/or for incorporation with the output of mask-aware vision-language captioning model. In response, the mask-aware regional captioning system 106 on the server device(s) 102 generates the image captions using the mask-aware vision-language captioning model with the modified parameters. The server device(s) 102 then provides the image captions to the client device(s) 110 for display and/or further processing.

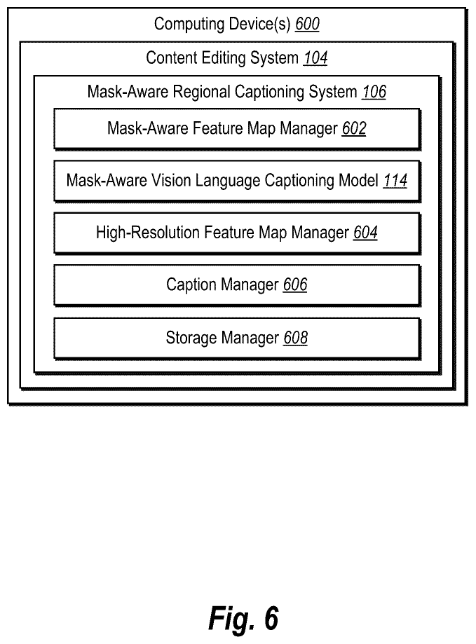

Although FIG. 1 illustrates the mask-aware regional captioning system 106 implemented with regard to the server device(s) 102, different components of the mask-aware regional captioning system 106 are able to be implemented by a variety of devices within the system environment 100. For instance, in some instances, a different computing device (e.g., the client device(s) 110) or a separate server from the server device(s) 102 implements one or more (or all) components of the mask-aware regional captioning system 106. Indeed, as shown in FIG. 1, the client device(s) 110 includes the mask-aware regional captioning system 106. Example components of the mask-aware regional captioning system 106 will be described below with regard to FIG. 6.

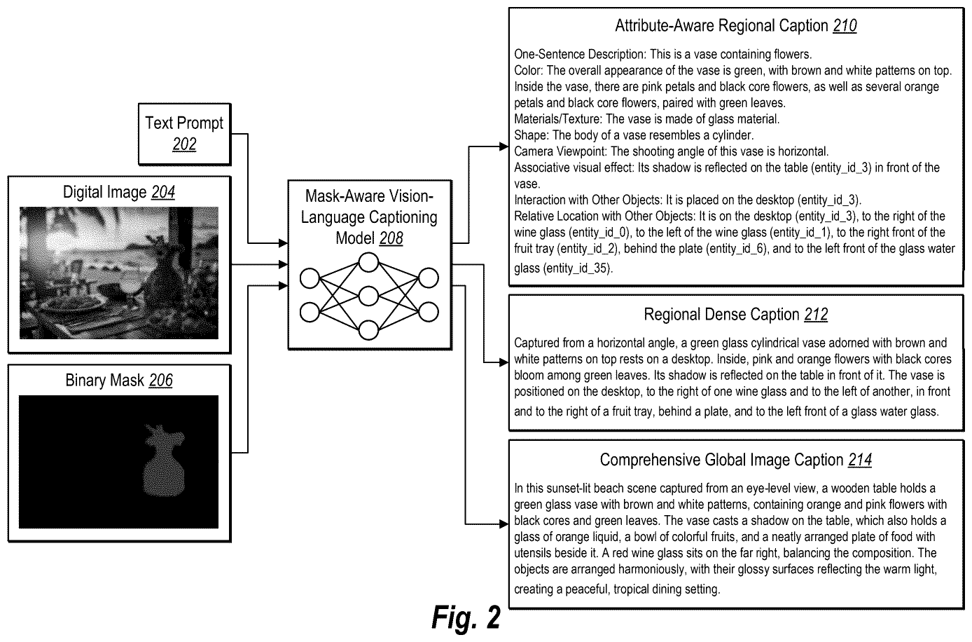

As mentioned above, in one or more implementations, the mask-aware regional captioning system 106 generates captions for a digital image utilizing a mask-aware vision-language captioning model. In particular, the mask-aware regional captioning system 106 generates the captions for the digital image at varying levels of granularity based on a binary mask of the digital image. For example, FIG. 2 illustrates an overview diagram of the mask-aware regional captioning system 106 generating image captions at varying granularity levels utilizing a mask-aware vision-language captioning model 208 in accordance with one or more embodiments.

As illustrated in FIG. 2, in some embodiments, the mask-aware regional captioning system 106 receives a text prompt. Specifically, the mask-aware regional captioning system 106 receives a text prompt 202, e.g., via a graphical user interface of a client device. Further, in some implementations, the mask-aware regional captioning system 106 receives a digital image 204 with a binary mask 206 that indicates a region of interest in the digital image. In these or other embodiments, from the text prompt 202, the digital image 204, and the binary mask 206, the mask-aware regional captioning system 106 utilizes a mask-aware vision-language captioning model 208 (e.g., mask-aware vision-language captioning model(s) 114) to generate captions for the digital image 204.

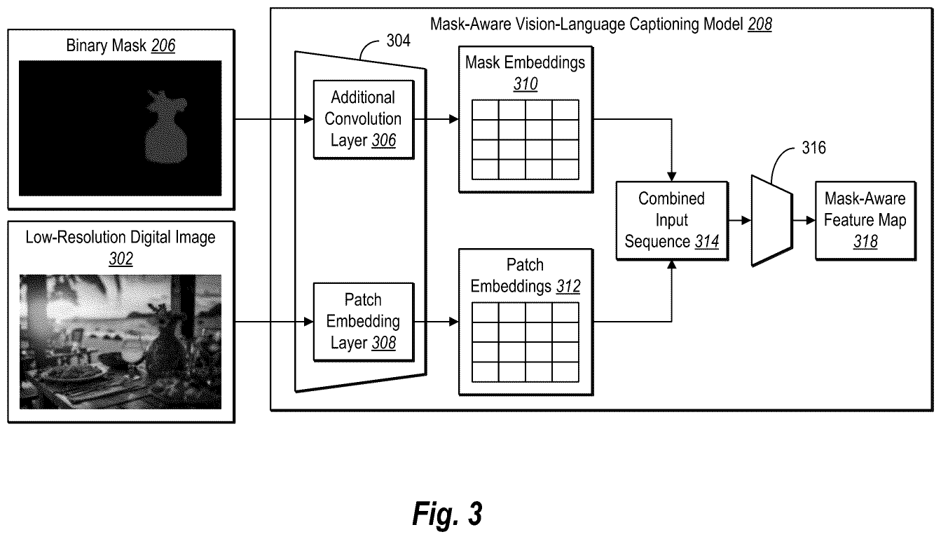

As just mentioned, in one or more embodiments, the mask-aware regional captioning system 106 generates the captions from the digital image 204 and the binary mask 206. Specifically, the mask-aware regional captioning system 106 utilizes a low-resolution version of the digital image and the binary mask 206 to generate a mask-aware feature map. For instance, the mask-aware regional captioning system 106 utilizes a mask-aware encoder of the mask-aware vision-language captioning model 208 to generate the mask-aware feature map as part of generating the captions. Additional detail regarding generating the mask-aware feature map is provided with respect to FIG. 3.

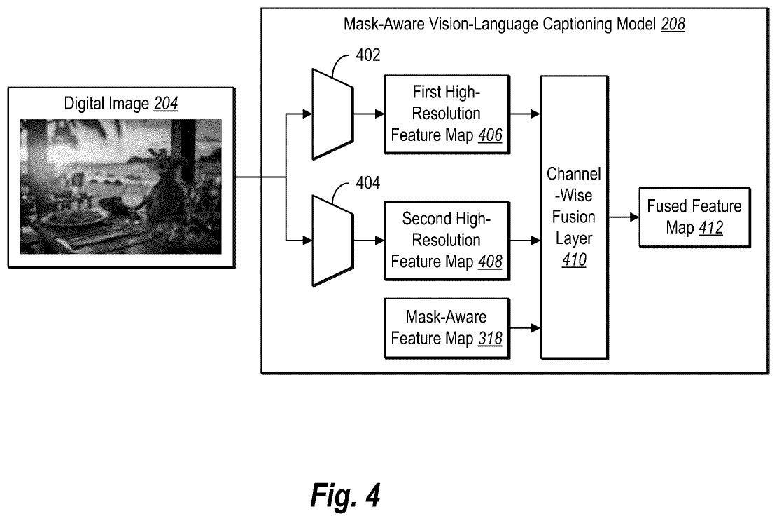

Further, the mask-aware regional captioning system 106 generates a fused feature map as part of generating the captions utilizing the mask-aware vision-language captioning model 208. In particular, the mask-aware regional captioning system 106 generates high-resolution feature maps utilizing high-resolution encoders of the mask-aware vision-language captioning model 208. Moreover, in one or more implementations, the mask-aware regional captioning system 106 fuses the high-resolution feature maps with the mask-aware feature map to generate the fused feature map. Additional detail regarding generating the fused feature map is provided with respect to FIG. 4.

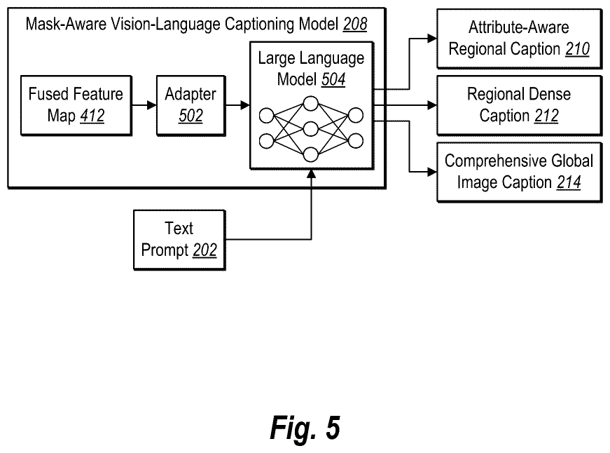

Furthermore, in some embodiments, the mask-aware regional captioning system 106 generates the captions at varying granularity levels. Specifically, the mask-aware regional captioning system 106 utilizes a large language model of the mask-aware vision-language captioning model 208 to generate the captions at varying granularity levels based on the text prompt 202. For example, the mask-aware regional captioning system 106 generates captions at varying levels of granularity by generating an attribute-aware regional caption 210, a regional dense caption 212, and/or a comprehensive global image caption 214. Additional detail regarding generating the captions at varying levels of granularity is provided with respect to FIG. 5.

As noted above, in some implementations, the mask-aware regional captioning system 106 generates a mask-aware feature map based on a binary mask as part of generating captions for a digital image. Indeed, in one or more embodiments, the mask-aware regional captioning system 106 utilizes a binary mask indicating a region of interest of a digital image. FIG. 3 illustrates a diagram of the mask-aware regional captioning system 106 generating a mask-aware feature map in accordance with one or more embodiments.

As shown in FIG. 3, in one or more implementations, the mask-aware regional captioning system 106 accesses a binary mask 206. In some embodiments, the binary mask 206 indicates a region of interest of a digital image (e.g., digital image 204). To illustrate, the binary mask 206 indicates a region of interest of the digital image that includes a vase with flowers as seen in the digital image. For example, the binary mask 206 indicates a region of interest in a low-resolution version of the digital image. Additionally, in some implementations, the region of interest of the digital image includes a region indicated by a text prompt. In one example, the mask-aware regional captioning system 106 accesses the binary mask 206(M) with a single channel (e.g., grayscale) as follows: M∈ [symbol] ^{H}^{_{LR}}^{×W}^{_{LR}}^{×1}.

As further illustrated in FIG. 3, in one or more embodiments, the mask-aware regional captioning system 106 accesses a low-resolution version 302 of the digital image (also referred to as a low-resolution digital image 302). In particular, a low-resolution version of the digital image includes a lower-resolution version of a high-resolution digital image. In one or more implementations, the high-resolution digital image includes a digital image with a height and width of at least 1024 pixels with three channels (e.g., red, green, and blue). In this example, the high-resolution image is illustrated as follows: I_{HR} ∈ [symbol] ^{H}^{_{HR}}^{×W}^{_{HR}}^{×3} where H_{HR}=W_{HR}=1024. In some embodiments, the low-resolution digital image includes a digital image with a height of 336 pixels, a width of 336 pixels, and includes three channels (e.g., red, green, and blue). In this example, the low-resolution image is illustrated as follows: I_{LR} ∈ [symbol] ^{H}^{_{LR}}^{×W}^{_{LR}}^{×3} where H_{LR}=W_{LR}=336.

As additionally shown in FIG. 3, in some implementations, the mask-aware regional captioning system 106 generates embeddings. Indeed, the mask-aware regional captioning system 106 generates the embeddings based on the binary mask 206 and the low-resolution digital image 302. For example, the mask-aware regional captioning system 106 generates the embeddings utilizing an image encoder neural network 304 of the mask-aware vision-language captioning model 208 to generate embeddings.

In one or more embodiments, an image encoder neural network includes a neural network designed to process and extract meaningful representations from images by converting image data (e.g., raw pixel data) into a structured, lower-dimensional feature space. Specifically, an image encoder neural network utilizes convolutional or transformer-based architectures to learn hierarchical patterns, spatial relationships, and/or semantic information for use in downstream tasks such as captioning. In one or more implementations, an image encoder includes an additional convolutional layer (e.g., auxiliary alpha channel) allowing for focus on specific regions (e.g., a region of interest) within an image. For example, the mask-aware regional captioning system 106 utilizes the additional convolutional layer with the binary mask 206 to focus on the region of interest in the digital image as described further below.

As mentioned previously, in some embodiments, the mask-aware regional captioning system 106 generates embeddings utilizing the image encoder neural network 304 based on the low-resolution digital image 302. In particular, the mask-aware regional captioning system 106 generates embeddings utilizing a convolutional layer of the image encoder neural network 304 such as a patch embedding layer 308.

In some implementations, a patch embedding layer includes a neural network component that converts the digital image into a sequence of smaller patches and maps them into a high-dimensional feature space. Specifically, a patch embedding layer transforms each patch of the digital image into an embedding vector (e.g., a patch embedding). For example, the mask-aware regional captioning system 106 utilizes the patch embedding layer 308 to generate patch embeddings 312 from the low-resolution digital image 302. To illustrate, the mask-aware regional captioning system 106 utilizes the patch embedding layer 308 (Conv_{RGB}) to generate the patch embeddings 312 (E_{patch}) according to Equation (1):

E_{patch}=Conv_{RGB}(I_{LR}) (1)

In Equation (1), Conv_{RGB}(⋅) maps the low-resolution digital image 302 (I_{LR}) into the patch embeddings E_{patch} ∈ [symbol] ^{C×H′×W′}. In this example, C represents the number of output channels and H′ and W′ represent the spatial dimensions of the patch embeddings 312.

As noted previously, in one or more embodiments, the mask-aware regional captioning system 106 generates embeddings utilizing the image encoder neural network 304 based on the binary mask 206. In particular, the mask-aware regional captioning system 106 utilizes an additional convolutional layer 306 of the image encoder neural network 304 to generate mask embeddings 310 from the binary mask 206. To illustrate, the mask-aware regional captioning system 106 utilizes the additional convolutional layer 306 to generate the mask embeddings 310 (Eₘₐₛₖ) according to Equation (2):

Eₘₐₛₖ=Conv_{α}(M) (2)

In Equation (2), Conv_{α} represents the additional convolutional layer 306 with the same parameters as Conv_{RGB} except for the input channels. In these or other embodiments, the input channels are set to 1 for the binary mask 206. To further illustrate, the mask embeddings 310 are represented as follows: Eₘₐₛₖ ∈ [symbol] ^{C×H′×W′}. Further, in one or more implementations, the mask-aware regional captioning system 106 generates the mask embedding 310 and the patch embeddings 312 simultaneously.

As further illustrated in FIG. 3, in some embodiments, the mask-aware regional captioning system 106 generates a combined input sequence 314. Specifically, the mask-aware regional captioning system 106 combines and flattens the mask embeddings 310 and the patch embeddings 312 to generate the combined input sequence 314. For example, by combining the mask embeddings 310 and the patch embeddings 312 into the combined input sequence 314, the mask-aware regional captioning system 106 aligns the mask-referred region (e.g., the region of interest) of the binary mask 206 with the low-resolution digital image 302.

In some implementations, the mask-aware regional captioning system 106 flattens the mask embeddings 310 and the patch embeddings 312 by removing the spatial information thereof. Moreover, in one or more embodiments, the mask-aware regional captioning system 106 sums the mask embeddings 310 and the patch embeddings 312 to generate the combined input sequence 314. To illustrate, the mask-aware regional captioning system 106 generates the combined input sequence 314 according to Equation (3):

E_{seq}=Flatten(E_{patch}+Eₘₐₛₖ)^{T}∈ [symbol] ^{N×C} (3)

In Equation (3), N=H′×W′ and represents the number of patches.

As also depicted in FIG. 3, in one or more implementations, the mask-aware regional captioning system 106 generates a mask-aware feature map 318 utilizing a mask-aware encoder 316 of the mask-aware vision-language captioning model 208. In some embodiments, a mask-aware encoder includes a machine learning model that converts visual input into numerical representations (e.g., embeddings). In particular, the mask-aware regional captioning system 106 encodes features of the region of interest of the digital image based on the binary mask 206 and the low-resolution digital image 302. For example, the mask-aware regional captioning system 106 generates the mask-aware feature map 318 from the combined input sequence 314 utilizing the mask-aware encoder 316.

To illustrate, the mask-aware regional captioning system 106 generates the mask-aware feature map 318 (F_{M}) from the combined input sequence 314 according to Equation (4):

F_{M}=Encoder_{M}(E) (4)

In Equation (4), F_{M} ∈ [symbol] ^{N×C}^{_{M}} and captures the region information of the low-resolution digital image 302 and the binary mask 206.

As previously mentioned, in some implementations, the mask-aware regional captioning system 106 generates a fused feature map as part of generating image captions for a digital image. Indeed, in one or more embodiments, the mask-aware regional captioning system 106 generates the fused feature map based on high-resolution feature maps and a mask-aware feature map. FIG. 4 illustrates a diagram of the mask-aware regional captioning system 106 generating a fused feature map in accordance with one or more embodiments.

As portrayed in FIG. 4, in one or more implementations, the mask-aware regional captioning system 106 utilizes high-resolution encoders to generate high-resolution feature maps of the digital image 204. Specifically, the mask-aware regional captioning system 106 generates the high-resolution feature maps based on the high-resolution version of the digital image 204. For example, the mask-aware regional captioning system 106 utilizes a first high-resolution encoder 402 and a second high-resolution encoder 404 of the mask-aware vision-language captioning model 208 to generate the high-resolution feature maps.

As further illustrated in FIG. 4, in some embodiments, the mask-aware regional captioning system 106 utilizes the first high-resolution encoder 402 to generate a first high-resolution feature map 406. In some implementations, the first high-resolution encoder 402 includes a convolutional neural network that efficiently processes high-resolution digital images. In particular, the first high-resolution encoder 402 encodes features of the digital image 204 into a high-resolution feature map. For example, the first high-resolution encoder 402 identifies and encodes features such as fine-grained features of the digital image into a high-resolution feature map. To illustrate, the mask-aware regional captioning system 106 generates the first high-resolution feature map 406 encoding fine-grained visual details of the digital image 204 (e.g., utilizing the example architecture of the first high-resolution encoder 402 as discussed below).

As additionally shown in FIG. 4, in one or more embodiments, the mask-aware regional captioning system 106 utilizes the second high-resolution encoder 404 to generate a second high-resolution feature map 408. In one or more implementations, the second high-resolution encoder 404 includes a vision transformer-based machine learning model that segments and extracts features of high-resolution digital images. Specifically, the second high-resolution encoder 404 processes high-resolution images by extracting features from a high-resolution digital image to create a high-resolution feature map. For example, the second high-resolution feature map extracts detailed spatial information from a high-resolution digital image. To illustrate, the mask-aware regional captioning system 106 generates the second high-resolution feature map 408 encoding detailed structural and/or semantic level information of the digital image 204 (e.g., utilizing the example architecture of the second high-resolution encoder 404 as discussed below).

To illustrate, in some embodiments, the mask-aware regional captioning system 106 generates the first high-resolution feature map (F_{HR1}) according to Equation (5) and the second high-resolution feature map (F_{HR2}) according to Equation (6):

F_{HR1}=Flatten(Encoder_{ConvNeXT}(I_{HR})) (5)

F_{HR2}=Flatten(Encoder_{SAM}(I_{HR})) (6)

In Equation (5), the mask-aware regional captioning system 106 generates the first high-resolution feature map 406 such that F_{HR1} ∈ [symbol] ^{N′×C}^{_{HR1}}. Further, Equation (5) includes an example architecture, ConvNeXT, of the first high-resolution encoder 402. In Equation (6), the mask-aware regional captioning system 106 generates the second high-resolution feature map 408 such that F_{HR2} ∈ [symbol] ^{N′×C}^{_{HR2}}. Additionally, Equation (6) includes an example encoder architecture, from the Segment Anything Model (SAM), of the second high-resolution encoder 404. Moreover, in both the first high-resolution feature map 406 (F_{HR1}) and the second high-resolution feature map 408 (F_{HR2}), N′=H″×W″.

As further illustrated in FIG. 4, in some implementations, the mask-aware regional captioning system 106 utilizes a channel-wise fusion layer 410 of the mask-aware vision-language captioning model 208 to generate a fused feature map 412. In one or more embodiments, a channel-wise fusion layer includes a neural network component that integrates different types of information. In particular, a channel-wise fusion layer merges multiple feature maps along the channel dimension to create a unified representation (e.g., a fused feature map) using operations like concatenation, etc.

In one or more implementations, the mask-aware regional captioning system 106 generates the fused feature map 412 utilizing the channel-wise fusion layer 410 from the first high-resolution feature map 406, the second high-resolution feature map 408 and the mask-aware feature map 318. Specifically, the mask-aware regional captioning system 106 generates the fused feature map 412 to include unified features of the first high-resolution feature map 406, the second high-resolution feature map 408, and the mask-aware feature map 318. For example, the mask-aware regional captioning system 106 generates the fused feature map 412 to include the fine-grained features (e.g., the fine-grained visual details) of the first high-resolution feature map 406, the detailed spatial information (e.g., the detailed structural and/or semantic level information) of the second high-resolution feature map 408, and the mask features of the mask-aware feature map 318.

In some embodiments, the mask-aware regional captioning system 106 generates the fused feature map 412 by modifying the spatial dimensions of the mask-aware feature map 318 to match the spatial dimensions of the first high-resolution feature map 406 and the second high-resolution feature map 408. In particular, the mask-aware regional captioning system 106 resizes the mask-aware feature map 318 and interpolates the resized mask-aware feature map 318 to match the spatial dimensions of the one or more high-resolution feature maps. Furthermore, in some implementations, the mask-aware regional captioning system 106 flattens the mask-aware feature map 318 into a sequence for concatenation along the channel dimension of the channel-wise fusion layer. Additionally, in these or other embodiments, the mask-aware regional captioning system 106 concatenates the mask-aware feature map 318 and the one or more high-resolution feature maps along a channel dimension of the channel-wise fusion layer.

To illustrate, the mask-aware regional captioning system 106 flattens the resized and interpolated fused feature map (F_{M}′) according to Equation (7):

F_{M}′=Flatten(Interpolate(F̅_{M})) (7)

In Equation (7), the mask-aware regional captioning system 106 flattens the resized and interpolated fused feature map (F_{M}′) such that F_{M}′∈ [symbol] ^{N′×C}^{_{M}}. Further, in one or more embodiments, the mask-aware regional captioning system 106 concatenates the first high-resolution feature map 406, the second high-resolution feature map 408, and the mask-aware feature map 318 along the channel dimension of the channel-wise fusion layer 410 to generate the fused feature map 412 (F_{fusion}) according to Equation (8):

F_{fusion}=[F_{M}′;F_{HR1};F_{HR2}] (8)

In this example, the mask-aware regional captioning system 106 generates the fused feature map 412 such that F_{fusion} ∈ [symbol] ^{N″×C}^{_{fusion}} where C_{fusion}=C_{M}+C_{HR1}+C_{HR2}.

As previously noted, in one or more implementations, the mask-aware regional captioning system 106 generates image captions for a digital image at varying granularity levels. Indeed, in some embodiments, the mask-aware regional captioning system 106 generates the image captions at varying granularity levels based on a fused feature map with a large language model of a mask-aware vision-language captioning model. FIG. 5 illustrates a diagram of the mask-aware regional captioning system 106 generating image captions at varying levels of granularity utilizing in accordance with one or more embodiments.

As depicted in FIG. 5, in some implementations, the mask-aware regional captioning system 106 maps the fused feature map 412 into an embedding space of a large language model 504 of the mask-aware vision-language captioning model 208. Specifically, the mask-aware regional captioning system 106 utilizes an adapter layer (i.e., adapter 502) to map the fused feature map 412 into the embedding space of the large language model 504. To illustrate, the mask-aware regional captioning system 106 maps the fused feature map 412 to generate an adapted embedding space (F_{adapted}) of the large language model 504 according to Equation (9):

F_{adapted}=Adapter(F_{fusion}) (9)

In one or more embodiments, the mask-aware regional captioning system 106 adapts the embedding space of the large language model 504 such that F_{adapted} ∈ [symbol] ^{N′×D′}. In these or other embodiments, N′ represents the adapted sequence length for the large language model 504 and D′ represents the embedding dimension for the large language model 504.

In one or more implementations, the large language model 504 includes an artificial intelligence model capable of processing and generating natural language text or other language-based prompts using language understanding. In particular, large language models are trained on large amounts of data to learn patterns and rules of language. As such, a large language model post-training is capable of generating outputs such as image captions for digital images. Further, in some embodiments, a large language model includes or refers to one or more transformer-based neural networks capable of processing language-based prompts (e.g., natural language text) to generate outputs that range from predictive outputs, analyses, or combinations of data within stored content items. In particular, a large language model includes parameters trained (e.g., via deep learning) on large amounts of data to learn patterns and rules of language for generating image captions for digital images.

As also depicted in FIG. 5, in some embodiments, the mask-aware regional captioning system 106 receives the text prompt 202. In particular, the mask-aware regional captioning system 106 receives the text prompt for the large language model 504 via a client device. For example, the mask-aware regional captioning system 106 receives the text prompt 202 which includes a request for a description of a digital image (e.g., digital image 204) with reference to a region of interest of the digital image. To illustrate, the mask-aware regional captioning system 106 receives the text prompt 202 requesting a description of the region of interest of the digital image and/or a description of the relationship of the region of interest with other regions of the digital image (e.g., adjacent regions or the digital image globally).

As further illustrated in FIG. 5, in some implementations, the mask-aware regional captioning system 106 generates an image caption of the digital image based on the text prompt 202 and the fused feature map 412. Specifically, the mask-aware regional captioning system 106 generates the image caption based on the adapted features (e.g., adapted to the embedding space of the large language model 504) of the fused feature map 412 and the text prompt 202. To illustrate, the mask-aware regional captioning system 106 generates the image caption according to Equation (10):

y=LLM(F_{adapted},I) (10)

In Equation (10), y represents the output (e.g., the image caption) generated by the large language model 504 conditioned on the visual features of the fused feature map 412 and task-specific instructions (I) of the text prompt 202. In these or other embodiments, the task-specific instructions include the description request of the region of interest of the text prompt 202 as described above.

As additionally shown in FIG. 5, in one or more embodiments, the mask-aware regional captioning system 106 utilizes the large language model 504 to generate the image caption describing the region of interest based on the text prompt 202. Indeed, the mask-aware regional captioning system 106 generates the image caption with reference to the region of interest as requested in the text prompt 202. For example, the mask-aware regional captioning system 106 generates the image caption to include an attribute-aware regional caption 210, a regional dense caption 212, and/or a comprehensive global image caption 214.

In one or more implementations, the mask-aware regional captioning system 106 generates the image caption to include the attribute-aware regional caption 210 describing details of the region of interest. In particular, an attribute-aware regional caption includes detailed descriptions of specific regions (e.g., a region of interest or other regions) in a digital image while incorporating attribute-level information such as color, shape, texture, or object properties within a region. For example, the attribute-aware regional caption 210 enhances regional captions by including fine-grained attributes that make descriptions more precise and informative. To illustrate, rather than a caption including “a dog on the grass,” an attribute-aware regional caption includes “a fluffy golden retriever sitting on the green grass.”

To further illustrate, the mask-aware regional captioning system 106 generates the attribute-aware regional caption 210 for the region of interest of the digital image 204 to include the following detailed descriptions:
One-Sentence Description: This is a vase containing flowers.
Color: The overall appearance of the vase is green, with brown and white patterns on top. Inside the vase, there are pink petals and black core flowers, as well as several orange petals and black core flowers, paired with green leaves.
Materials/Texture: The vase is made of glass material.
Shape: The body of a vase resembles a cylinder.
Camera Viewpoint: The shooting angle of this vase is horizontal.
Associative visual effect: Its shadow is reflected on the table (entity_id_3) in front of the vase.
Interaction with Other Objects: It is placed on the desktop (entity_id_3).
Relative Location with Other Objects: It is on the desktop (entity_id_3), to the right of the wine glass entity_id_0), to the left of the wine glass (entity_id_1), to the right front of the fruit tray (entity_id_2), behind the plate (entity_id_6), and to the left front of the glass water glass (entity_id_35).

In some embodiments, the mask-aware regional captioning system 106 generates the image caption to include the regional dense caption 212 describing the region of interest with respect to one or more additional regions of the digital image. Specifically, a regional dense caption includes multiple detailed descriptions for various regions within an image or a detailed description of a region of interest with respect to adjacent regions of the digital image. Indeed, a regional dense caption provides a comprehensive understanding of the content of the digital image at a localized level. For example, a regional dense caption describes multiple objects and interactions in the scene of the digital image with fine granularity. To illustrate, in an image of a kitchen, it might generate captions like “a red apple on the wooden table,” “a white coffee mug next to a book,” and “a black cat sitting on the chair.”

To further illustrate, the mask-aware regional captioning system 106 generates the regional dense caption 212 of the digital image 204 to include the following detailed descriptions: “Captured from a horizontal angle, a green glass cylindrical vase adorned with brown and white patterns on top rests on a desktop. Inside, pink and orange flowers with black cores bloom among green leaves. Its shadow is reflected on the table in front of it. The vase is positioned on the desktop, to the right of one wine glass and to the left of another, in front and to the right of a fruit tray, behind a plate, and to the left front of a glass water glass.”

In some implementations, the mask-aware regional captioning system 106 generates the image caption to include the comprehensive global image caption 214 describing the region of interest of the digital image within a global context of the digital image. In particular, a comprehensive global image caption includes a holistic caption that summarizes the entire image with reference to the region of interest in a coherent and meaningful way. Indeed, a comprehensive global image caption focuses on describing the overall context rather than individual elements. For instance, for an image of a beach scene, a comprehensive global image caption 214 includes “a sunny beach with people playing volleyball and waves crashing on the shore.”

To further illustrate, the mask-aware regional captioning system 106 generates the regional dense caption 212 of the digital image 204 to include the following detailed descriptions: “In this sunset-lit beach scene captured from an eye-level view, a wooden table holds a green glass vase with brown and white patterns, containing orange and pink flowers with black cores and green leaves. The vase casts a shadow on the table, which also holds a glass of orange liquid, a bowl of colorful fruits, and a neatly arranged plate of food with utensils beside it. A red wine glass sits on the far right, balancing the composition. The objects are arranged harmoniously, with their glossy surfaces reflecting the warm light, creating a peaceful, tropical dining setting.”

Moreover, in one or more embodiments, the mask-aware regional captioning system 106 trains the mask-aware vision-language captioning model 208. In one or more implementations, the mask-aware regional captioning system 106 trains the mask-aware vision-language captioning model 208 in an end-to-end manner. For example, mask-aware regional captioning system 106 trains the mask-aware vision-language captioning model 208 based on a negative log-likelihood loss. Specifically, the mask-aware regional captioning system 106 modifies/updates the model parameters utilizing a negative log-likelihood loss according to Loss Function (1):

$$L = - {\sum }_{D} {\sum }_{i = 1}^{N} log p ( {y}_{i} \vert {F}_{adapted} , I , {y}_{< i} ) \qquad ( 1 )$$

In Loss Function (1), D represents the training dataset, N represents the total number of tokens or features in each sequence, and yᵢ represents the language tokens in the generated output.

In one or more embodiments, the mask-aware regional captioning system 106 trains the mask-aware vision-language captioning model 208 utilizing a three-stage strategy. Specifically, in a first training stage (e.g., pre-training) the mask-aware regional captioning system 106 optimizes the projector to align the visual features with the word embeddings of the large language model 504. Indeed, in these or other embodiments, the mask-aware regional captioning system 106 freezes the parameters of the image encoders (e.g., the image encoder neural network 304 and the first and second high-resolution encoders) during the first training stage. In some implementations, the mask-aware regional captioning system 106 performs the pre-training stage utilizing the LLaVA-Pretrain dataset, with the mask in this stage highlighting all regions of the image.

In a second training stage, in one or more embodiments, the mask-aware regional captioning system 106 aligns the image features of the digital image and the mask features of the binary mask 206 for the mask-aware encoder 316. In these or other embodiments, only the parameters of the mask-aware encoder 316 are trainable (e.g., all other parameters are frozen). In one or more implementations, the mask-aware regional captioning system 106 trains the mask-aware encoder 316 utilizing an annotated dataset (described below) as well as additional training datasets (e.g., GranD, RefCOCO, RefCOCO+, and/or RefCOCOg).

In a third training stage, in some embodiments, the mask-aware regional captioning system 106 modifies all parameters of the mask-aware vision-language captioning model 208 utilizing the annotated dataset. In particular, the mask-aware regional captioning system 106 fine-tunes the mask-aware vision-language captioning model 208 to accurately handle compositional referring expressions, improving the ability of the mask-aware regional captioning system 106 to generate detailed, attribute-aware captions.

Furthermore, in one or more implementations, the mask-aware regional captioning system 106 modifies the parameters of the mask-aware vision-language captioning model 208 utilizing an annotated dataset of high-quality images from stock image sources including diverse and complex scenes (e.g., the COMPOSITIONCAP dataset). In particular, the mask-aware regional captioning system 106 trains the mask-aware vision-language captioning model 208 with the annotated dataset for attribute-aware regional captioning, regional dense captioning, and/or comprehensive global image captioning. For instance, the annotated data set includes an annotated, high-quality dataset including high-quality images from stock image sources.

In one example, the annotated dataset includes entity masks (e.g., generated from the images utilizing an image segmentation machine learning model) for entities in the images. Additionally, in one or more embodiments, the annotations describe the attributes of the image entities including region compositional attribute descriptions. Specifically, each image of the annotated dataset includes multiple entities (e.g., 14,590 entities across 5,392 images) and multiple attribute descriptions for each entity (e.g., 186,490 attribute descriptions). Moreover, in one or more implementations, in addition to training with the annotated dataset, the mask-aware regional captioning system 106 trains the mask-aware vision-language model 208 utilizing an instruction-tuning dataset (e.g., DOCCI) containing long, human-annotated English descriptions for 15,000 images.

Furthermore, in some implementations, the mask-aware regional captioning system 106 tests the mask-aware vision-language captioning model 208 utilizing an out-of-domain test set sourced from the Open Images dataset. In particular, the test set includes 1,000 images featuring diverse and complex scenes for annotation with 7,215 masked entities and 19,326 attribute-specific region captions.

In some embodiments, each image of the annotated dataset (e.g., COMPOSITIONCAP) includes region compositional attribute descriptions. For example, each image includes attribute-specific region captions including attributes such as category name, body shape, skin texture and color, clothing, shoes, accessories, interaction with other objects, body pose/gesture, other attributes, relative location with other objects, color, materials/texture, camera viewpoint, associative visual effect, shape, facial expression, hair, age range, object pose for deformable objects, and style.

Further, the image resolution distribution across the images in the annotated dataset reflects a high overall quality of the images. For example, the large majority of the images in the annotated dataset have a resolution of 1000×1000 pixels. Additionally, in one or more embodiments, the mask-aware regional captioning system 106 includes the following distribution of attributes (from least to greatest): style 0.18%, object pose for deformable object 1.27%, facial expression 2.00%, other attributes 2.55%, hair 2.83%, age range 2.99%, skin texture and color 3.06%, clothing shoes accessories 3.11%, body shape 3.11%, body pose/gesture 3.13%, associative visual effect 6.16%, materials/texture 7.05%, camera viewpoint 10.78%, color! 10.84%, interaction with other objects 12.98%, relative location with other objects 13.97%, and category name 14.01%.

Compared to the mask-aware regional captioning system 106, conventional vision-language models perform poorly on the three tasks (attribute-aware regional captioning, regional dense captioning, and/or comprehensive global image captioning). In particular, compared to the mask-aware regional captioning system 106, conventional vision-language models under both the zero-shot and supervised learning settings struggle to recognize both region referrals and attribute instructions precisely. Even strong open-source models (e.g., Intern VL-2-40B and LLaMA-3.2-90B) perform sub-optimally on the three tasks introduced by the annotated dataset as measured by semantic evaluation metrics. For instance, Intern VL-2-40B and LLaMA-3.2-90B achieve only 11.7 and 11.9 in METEOR, and 5.5 and 4.63 in CIDEr, respectively. Additionally, the performance of the API-based model GPT-4 is still unsatisfactory in this context.

In contrast, supervised learning results demonstrate that models trained with the annotated dataset exhibit significantly stronger performance. Further, the mask-aware regional captioning system 106 outperforms all other models, e.g., due to the incorporation of mask-aware encoders and multiple high-resolution encoders, which enhance the ability of the mask-aware regional captioning system 106 to recognize region referrals and attribute-specific instructions effectively.

TABLE 1

| | | RDC |
|---|---|---|
| | AARC | Grounding Score |
| Model | GPT4-as-a-Judge ↑ | (Acc@0.5) ↑ |
| ViP-LLaVA-13B | 38.46 | 74.37 |
| Alpha-CLIP-13B | 43.89 | 77.61 |
| LLaVA-HR-X | 45.76 | 79.15 |
| LLAMA-3.2-11B-Visison | 50.26 | 81.01 |
| Mask-aware vision-language | 56.84 | 83.49 |
| captioning model 208 | | |

Table 1 illustrates Attribute-Aware Regional Captioning (AARC) and Regional Dense Captioning (RDC) metrics for the mask-aware vision-language captioning model 208 relative to conventional models. As illustrated by Table 1, the mask-aware vision-language captioning model 208 outperforms conventional captioning models in both traditional image captioning evaluation methods and newly designed fine-grained evaluation techniques for the Attribute-Aware Regional Captioning (AARC) and Regional Dense Captioning (RDC) tasks. In particular, GPT-4 was implemented as a judge for the AARC task, where GPT-4 is fed a model's predictions, the image, and the ground truth to assess whether the model properly describes the attributes of the referred region. To better evaluate performance on the RDC task, a trained LLaVA-1.6-13B model using the COMPOSITIONCAP test set to predict bounding boxes for the region descriptions was used. For the RDC task, the Acc@0.5 assesses the quality of the predicted regional dense captions. As shown in Table 1, the mask-aware vision-language captioning model 208 achieves 56.84 on the AARC task and 83.49 on the RDC task, significantly outperforming the baseline models and indicating the superior capability of the mask-aware vision-language captioning model 208 in these tasks.

TABLE 2

| | | RefCOCOg | |
|---|---|---|---|
| Model | Region Referral | METEOR | CIDEr |
| GRIT | Bbox | 15.2 | 71.6 |
| Kosmos-2 | Bbox | 14.1 | 62.3 |
| OMG-LLaVA | Mask | 15.3 | — |
| GLaMM | Bbox | 16.2 | 105.0 |
| Osprey | Mask | 16.6 | 108.3 |
| Alpha-CLIP + LLaVA | Mask | 16.7 | 109.2 |
| RegionGPT | Mask | 16.9 | 109.9 |
| ControlCap | Bbox | 17.0 | 111.4 |
| Mask-aware vision- | Mask | 17.5 | 118.2 |
| language captioning | | | |
| model 208 | | | |

Table 2 illustrates the ability of the mask-aware vision-language captioning model 208 to recognize region referrals accurately relative to conventional models. Inp1, the mask-aware vision-language captioning model 208 outperforms the ability of other models to recognize region referrals accurately as illustrated by experiments on traditional Referring Expression Generation (REG) tasks. For example, using the RefCOCOg test set and calculating METEOR and CIDEr scores, Table 2 illustrates the improvement of the mask-aware vision-language captioning model 208 relative to conventional models, indicating a superior capability in region description.

Further, the mask-aware vision-language captioning model 208 improves over conventional captioning models as indicated by an ablation study from the perspective of vision encoder fusion and different visual referring inputs. In particular, the ablation includes two parts, (i) model design and (ii) region referral format.

Model design investigates the effects of different visual encoder architectures and feature fusion strategies. In model design models with mask-aware low-resolution encoders only achieve lower performance compared to those that incorporate high-resolution encoders. Specifically, the mask-aware vision-language captioning model 208 with low-resolution encoding only attains a CIDEr score of 97.62 compared with 127.95 achieved by the mask-aware vision-language captioning model 208.

Further, when investigating different high-resolution encoder architectures, the mask-aware vision-language captioning model 208 incorporating the ConvNeXt Encoder (CIDER score of 109.25) outperforms the mask-aware vision-language captioning model 208 incorporating the SAM encoder (CIDER score of 106.74). This result indicates that the combination of low-resolution and high-resolution encoder architecture significantly impacts model performance. In addition, the fusion strategy plays a crucial role. In particular, the mask-aware vision-language captioning model 208 with Self-Attention Fusion yields better results than the mask-aware vision-language captioning model 208 with Sequence Append Fusion indicating that simply appending sequences is a less effective method for feature fusion.

With regard to region referral format, replacing the precise segmentation masks with bounding boxes and mask contours leads to noticeable performance drops. This result underscores the importance of using detailed mask information (e.g., of the binary mask) for accurately grounding visual content within the digital image.

Turning to FIG. 6, additional detail will now be provided regarding various components and capabilities of the mask-aware regional captioning system 106. In particular, FIG. 6 illustrates an example schematic diagram of a computing device 600 (e.g., the server device(s) 102 and/or the client device(s) 110) implementing the mask-aware regional captioning system 106 in accordance with one or more embodiments of the present disclosure for components 600-608. As illustrated in FIG. 6, the mask-aware regional captioning system 106 includes a mask-aware feature map manager 602, a high-resolution feature map manager 604, a caption manager 606, and a storage manager 608.

The mask-aware feature map manager 602 generates a mask-aware feature map. Specifically, the mask-aware feature map manager 602 receives a digital image via a client device. Additionally, the mask-aware feature map manager 602 accesses a low-resolution version of the digital image and a binary mask of the low-resolution of the digital image. Further, the mask-aware feature map manager 602 utilizes a mask-aware encoder of a mask-aware vision-language captioning model to generate a mask-aware feature map based on the low-resolution version of the digital image and the binary mask. Moreover, the mask-aware feature map manager 602 interacts with other components to pass the mask-aware feature map for further processing.

Furthermore, the high-resolution feature map manager 604 generates high-resolution feature maps and a fused feature map of the digital image. In particular, the high-resolution feature map manager 604 receives the mask-aware feature map from the mask-aware feature map manager 602. Additionally, the high-resolution feature map manager 604 utilizes a first high-resolution encoder to generate a first high-resolution feature map encoding fine-grained features of the digital image. Further, the high-resolution feature map manager 604 generates a second high-resolution feature map encoding detailed spatial information of the digital image. Moreover, the high-resolution feature map manager 604 generates a fused feature map from the mask-aware feature map and the first and second high-resolution feature maps. Furthermore, the high-resolution feature map manager 604 interacts with other components to pass the fused feature map for further processing.

Additionally, the caption manager 606 generates an image caption for the digital image. Specifically, the caption manager 606 receives a text prompt via a client device and the fused feature map from the high-resolution feature map manager 604. Further, the caption manager 606 maps the fused feature map into an embedding space of a large language model of the mask-aware vision-language captioning model. Moreover, the caption manager 606 utilizes the large language model with the fused feature map mapped in the encoding space and the text prompt to generate the image caption. Indeed, the mask-aware regional captioning system 106 utilizes the large language model to generate the image caption to include an attribute-aware regional caption, a regional dense caption, and/or a comprehensive global image caption.

Furthermore, as shown in FIG. 6, the mask-aware regional captioning system 106 includes a storage manager 608. In one or more implementations, the storage manager 608 stores information (e.g., via one or more memory devices) on behalf of the mask-aware regional captioning system 106. For example, the storage manager 608 includes a database for storing digital images, low-resolution versions of digital images, binary masks of the digital images, mask embeddings, patch embeddings, combined input sequences, mask-aware feature maps, high-resolution feature maps, fused feature maps, and/or image captions (e.g., attribute-aware regional captions, regional dense captions, and/or comprehensive global image captions).

In some embodiments, each of the components 602-608 of the mask-aware regional captioning system 106 include software, hardware, or both. For example, the components 602-608 include one or more instructions stored on a computer-readable storage medium and executable by processors of one or more computing devices, such as a client device or server device. When executed by the one or more processors, the computer-executable instructions of the mask-aware regional captioning system 106 cause the computing device(s) to perform the methods described herein. Alternatively, the components 602-608 include hardware, such as a special-purpose processing device to perform a certain function or group of functions. Alternatively, the components 602-608 of the mask-aware regional captioning system 106 include a combination of computer-executable instructions and hardware.

Furthermore, the components 602-608 of the mask-aware regional captioning system 106 are, for example, implemented as one or more operating systems, as one or more stand-alone applications, as one or more modules of an application, as one or more plug-ins, as one or more library functions or functions that may be called by other applications, and/or as a cloud-computing model. Thus, in various embodiments, the components 602-608 of the mask-aware regional captioning system 106 are implemented as a stand-alone application, such as a desktop or mobile application. Furthermore, in various embodiments, the components 602-608 of the mask-aware regional captioning system 106 are implemented as one or more web-based applications hosted on a remote server. Alternatively, or additionally, the components 602-608 of the mask-aware regional captioning system 106 are implemented in a suite of mobile device applications or “apps.” For example, in one or more embodiments, the mask-aware regional captioning system 106 comprises or operates in connection with digital software applications such as ADOBE® FIREFLY® and/or ADOBE® PHOTOSHOP® CREATIVE CLOUD. The foregoing are either registered trademarks or trademarks of Adobe Inc. in the United States and/or other countries.

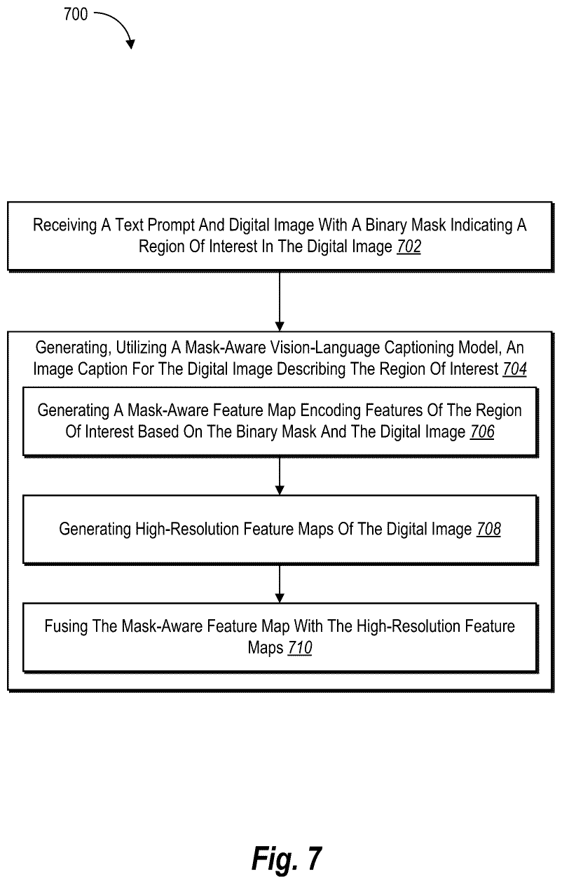

FIGS. 1-6, the corresponding text, and the examples provide a number of different systems, methods, and non-transitory computer readable media for generating captions for a digital image at multiple granularity levels utilizing a mask-aware vision-language captioning model. In addition to the foregoing, embodiments can also be described in terms of flowcharts comprising acts for accomplishing a particular result. For example, FIGS. 7-9 illustrate flowcharts of example sequences of acts in accordance with one or more embodiments.

While FIGS. 7-9 illustrate acts according to some embodiments, alternative embodiments may omit, add to, reorder, and/or modify any of the acts shown in FIGS. 7-9. The acts of FIGS. 7-9 can be performed as part of a method. Alternatively, a non-transitory computer readable medium can comprise instructions, that when executed by one or more processors, cause a computing device to perform the acts of FIGS. 7-9. In still further embodiments, a system can perform the acts of FIGS. 7-9. Additionally, the acts described herein may be repeated or performed in parallel with one another or in parallel with different instances of the same or other similar acts.

FIG. 7 illustrates an example series of acts 700 for generating an image caption describing a region of interest in a digital image utilizing a mask-aware vision-language captioning model. In some embodiments, the series of acts 700 includes an act 702 of receiving a text prompt and digital image with a binary mask indicating a region of interest in the digital image; an act 704 of generating, utilizing a mask-aware vision-language captioning model, an image caption for the digital image describing the region of interest; an act 706 of generating a mask-aware feature map encoding features of the region of interest based on the binary mask and the digital image; an act 708 of generating high-resolution feature maps of the digital image; and an act 710 of fusing the mask-aware feature map with the high-resolution feature maps.

In some embodiments, the act 702 includes receiving, by at least one processing device, a text prompt and a digital image with a binary mask indicating a region of interest in the digital image. In some implementations, the series of acts 704 also includes an act of generating, utilizing a mask-aware vision-language captioning model, an image caption for the digital image describing the region of interest based on the text prompt.

In some implementations, the series of acts 700 includes generating, utilizing a mask-aware encoder of the mask-aware vision-language captioning model, a mask-aware feature map encoding features of the region of interest based on the binary mask and a lower-resolution version of the digital image. In one or more embodiments, the series of acts 700 further includes an act of wherein generating, utilizing the mask-aware vision-language captioning model, the image caption for the digital image describing the region of interest based on the text prompt includes generating from the mask-aware feature map and the text prompt, utilizing a large language model of the mask-aware vision-language captioning model, the image caption.

In one or more embodiments, the series of acts 700 includes generating, utilizing a first higher-resolution encoder, a first high-resolution feature map encoding detailed spatial information of the digital image. Additionally, in one or more implementations, the series of acts 700 includes an act of generating, utilizing a second higher-resolution encoder, a second high-resolution feature map encoding fine-grained features of the digital image. In some embodiments, the series of acts 700 also includes an act of wherein generating, utilizing the mask-aware vision-language captioning model, the image caption for the digital image describing the region of interest based on the text prompt includes generating from the mask-aware feature map, the first high-resolution feature map, the second high-resolution feature map, and the text prompt, utilizing the large language model of the mask-aware vision-language captioning model, the image caption.

In one or more implementations, generating, utilizing the mask-aware encoder of the mask-aware vision-language captioning model, the mask-aware feature map encoding features of the region of interest based on the binary mask and the lower-resolution version of the digital image includes generating, utilizing an image encoder neural network, a combined input sequence aligning a mask-referred region of the binary mask with a low-resolution version of the digital image. In some implementations, the series of acts 700 further includes an act of generating, utilizing the mask-aware encoder, the mask-aware feature map from the combined input sequence.

In some embodiments, generating, utilizing the image encoder neural network, the combined input sequence aligning the mask-referred region of the binary mask with the low-resolution version of the digital image includes generating, utilizing a patch embedding layer of the image encoder neural network, patch embeddings from the low-resolution version of the digital image. Additionally, in one or more embodiments, the series of acts 700 includes an act of generating, utilizing a convolutional layer of the image encoder neural network, mask embeddings from the binary mask. In one or more implementations, the series of acts 700 also includes an act of generating the combined input sequence by combining the patch embeddings and the mask embeddings.

In some implementations, the series of acts 700 includes generating, utilizing a channel-wise fusion layer of the mask-aware vision-language captioning model, a fused feature map including unified features from a mask-aware feature map of the digital image, a first high-resolution feature map of the digital image, and a second high-resolution feature map of the digital image. In some embodiments, the series of acts 700 further includes an act of wherein generating, utilizing the mask-aware vision-language captioning model, the image caption for the digital image describing the region of interest based on the text prompt includes generating, utilizing a large language model of the mask-aware vision-language captioning model, the image caption based on the fused feature map.

In one or more embodiments, generating, utilizing the large language model of the mask-aware vision-language captioning model, the image caption based on the fused feature map includes mapping the fused feature map into an embedding space of the large language model of the mask-aware vision-language captioning model.

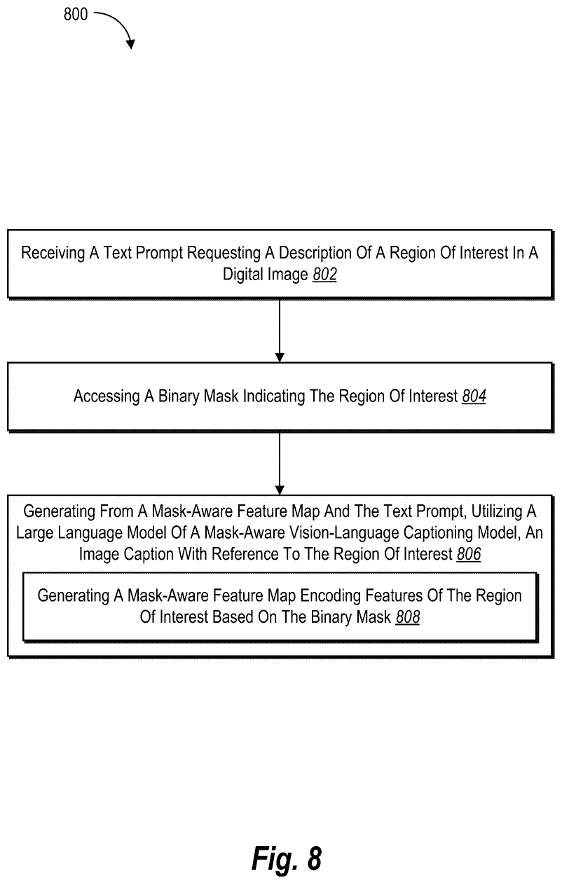

FIG. 8 illustrates an example series of acts 800 for generating an image caption from a mask-aware feature map utilizing a mask-aware vision-language captioning model. In some implementations, the series of acts 800 includes an act 802 of receiving a text prompt requesting a description of a region of interest in a digital image; an act 804 of accessing a binary mask indicating the region of interest; an act 806 of generating from a mask-aware feature map and the text prompt, utilizing a large language model of a mask-aware vision-language captioning model, an image caption with reference to the region of interest; and an act 808 of generating a mask-aware feature map encoding features of the region of interest based on the binary mask.

In one or more implementations, the act 802 includes receiving a text prompt requesting a description of a digital image with reference to a region of interest. Additionally, in one or more embodiments, the act 804 includes an act of access, by at least one processor, a binary mask indicating the region of interest within the digital image. In one or more implementations, the act 808 also includes an act of generating, utilizing a mask-aware encoder of a mask-aware vision-language captioning model, a mask-aware feature map encoding features of the region of interest based on the binary mask and a lower-resolution version of the digital image. In some embodiments, the series of acts 806 further includes an act of generating from the mask-aware feature map and the text prompt, utilizing a large language model of the mask-aware vision-language captioning model, an image caption of the digital image with reference to the region of interest as requested in the text prompt.

In some embodiments, the series of acts 800 includes generating, utilizing the mask-aware encoder of the mask-aware vision-language captioning model, the mask-aware feature map encoding features of the region of interest based on the binary mask and the lower-resolution version of the digital image by generating, utilizing a patch embedding layer of an image encoder network, patch embeddings from a low-resolution version of the digital image. Additionally, in some implementations, the series of acts 800 includes an act of generating, utilizing a convolutional layer of an image encoder neural network, mask embeddings from the binary mask. In one or more embodiments, the series of acts 800 also includes an act of generating a combined input sequence by combining the patch embeddings and the mask embeddings. In one or more implementations, the series of acts 800 further includes an act of generating, utilizing the mask-aware encoder, the mask-aware feature map from the combined input sequence.

In some implementations, generating the combined input sequence by combining the patch embeddings and the mask embeddings includes removing spatial information from the patch embeddings and the mask embeddings. Additionally, in some embodiments, the series of acts 800 includes an act of concatenating the patch embeddings and the mask embeddings together.

In one or more embodiments, the series of acts 800 includes generating, utilizing one or more higher-resolution encoders, one or more high-resolution feature maps encoding at least one of detailed spatial information of the digital image or fine-grained features of the digital image. In some implementations, the series of acts 800 also includes an act of wherein the image caption of the digital image is further generated from the one or more high-resolution feature maps.

In one or more implementations, the series of acts 800 includes generating from the mask-aware feature map and the text prompt, utilizing the large language model of the mask-aware vision-language captioning model, the image caption of the digital image with reference to the region of interest as requested in the text prompt by generating, utilizing a channel-wise fusion layer of the mask-aware vision-language captioning model, a fused feature map including unified features from the mask-aware feature map of the digital image and one or more high-resolution feature maps of the digital image. In one or more embodiments, the series of acts 800 further includes an act of mapping the fused feature map into an embedding space of the large language model of the mask-aware vision-language captioning model.

In some embodiments, generating, utilizing the channel-wise fusion layer of the mask-aware vision-language captioning model, the fused feature map including the unified features from the mask-aware feature map of the digital image and the one or more high-resolution feature maps of the digital image includes modifying spatial dimensions of the mask-aware feature map to match spatial dimensions of the one or more high-resolution feature maps. Additionally, in one or more implementations, the series of acts 800 includes an act of concatenating the mask-aware feature map and the one or more high-resolution feature maps along a channel dimension of the channel-wise fusion layer.

In some implementations, modifying the spatial dimensions of the mask-aware feature map to match the spatial dimensions of the one or more high-resolution feature maps includes resizing the mask-aware feature map. In some embodiments, the series of acts 800 also includes an act of interpolating the resized mask-aware feature map to match the spatial dimensions of the one or more high-resolution feature maps. In some implementations, the series of acts 800 further includes an act of flattening the mask-aware feature map into a sequence for concatenation along the channel dimension of the channel-wise fusion layer.

In one or more embodiments, generating the image caption of the digital image with reference to the region of interest as requested in the text prompt includes generating at least one of a regional dense caption describing the region of interest with respect to one or more additional regions of the digital image. Additionally, in one or more embodiments, the series of acts 800 includes an act of or a comprehensive global image caption describing the region of interest of the digital image within a global context of the digital image.

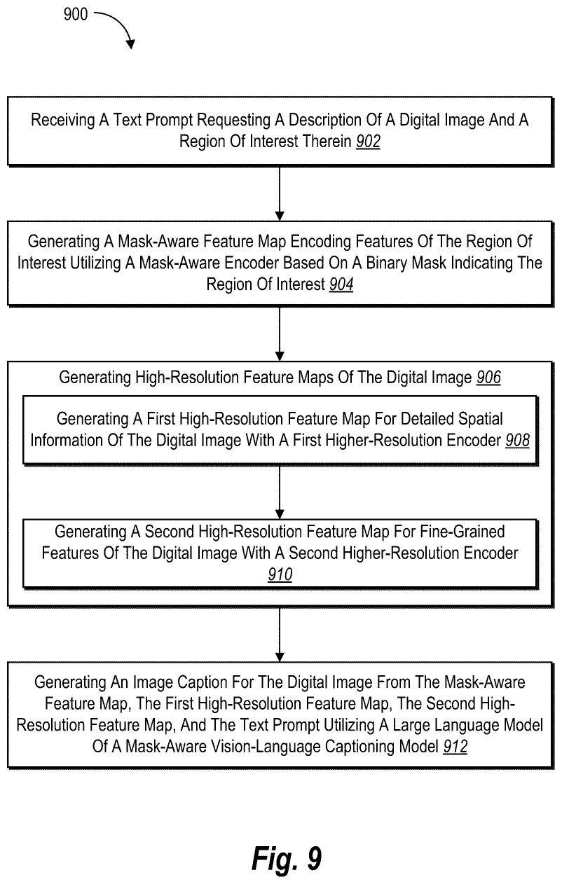

FIG. 9 illustrates an example series of acts 900 for generating a caption for an image from a mask-aware feature map and high-resolution feature maps. In one or more implementations, the series of acts 900 includes an act 902 of receiving a text prompt requesting a description of a digital image and a region of interest therein; an act 904 of generating a mask-aware feature map encoding features of the region of interest utilizing a mask-aware encoder based on a binary mask indicating the region of interest; an act 906 of generating high-resolution feature maps of the digital image; an act 908 of generating a first high-resolution feature map for detailed spatial information of the digital image with a first higher-resolution encoder; an act 910 of generating a second high-resolution feature map for fine-grained features of the digital image with a second higher-resolution encoder; and an act 912 of generating an image caption for the digital image from the mask-aware feature map, the first high-resolution feature map, the second high-resolution feature map, and the text prompt utilizing a large language model of a mask-aware vision-language captioning model

In one or more implementations, the act 902 includes receiving a text prompt requesting a description of a digital image with reference to a region of interest. In some embodiments, the act 904 also includes an act of generating, utilizing a mask-aware encoder of a mask-aware vision-language captioning model, a mask-aware feature map encoding features of the region of interest based on a lower-resolution version of the digital image and a binary mask indicating the region of interest within the lower-resolution version of the digital image. In some implementations, the act 908 further includes an act of generating, utilizing a first higher-resolution encoder, a first high-resolution feature map encoding detailed spatial information of the digital image. Additionally, in one or more embodiments, the act 910 includes an act of generating, utilizing a second higher-resolution encoder, a second high-resolution feature map encoding fine-grained features of the digital image. In one or more implementations, the act 912 also includes an act of generating from the mask-aware feature map, the first high-resolution feature map, the second high-resolution feature map, and the text prompt, utilizing a large language model of the mask-aware vision-language captioning model, an image caption of the digital image with reference to the region of interest as requested in the text prompt.

In some embodiments, the series of acts 900 includes mapping, utilizing an adapter layer of the mask-aware vision-language captioning model, a fused feature map into an embedding space of the large language model, the fused feature map based on the mask-aware feature map, the first high-resolution feature map, and the second high-resolution feature map.

In some implementations, the series of acts 900 includes generating the image caption to include an attribute-aware regional caption describing details of the region of interest.

In one or more embodiments, generating the image caption of the digital image with reference to the region of interest as requested in the text prompt includes generating the image caption to include a regional dense caption describing the region of interest with respect to one or more additional regions of the digital image.

In one or more implementations, generating the image caption of the digital image with reference to the region of interest as requested in the text prompt includes generating the image caption to include a comprehensive global image caption describing the region of interest of the digital image within a global context of the digital image.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media. Non-transitory computer-readable storage media (devices) includes optical and/or non-optical memory, disks, or caches that store computer data interpretable by one or more processors to execute particular functions as described herein. A “network” is defined as one or more data links that enable the transport of electronic data between computer systems and/or modules and/or other electronic devices. Information is transferred or provided over a network (either hardwired, wireless, or a combination of hardwired or wireless) to a computer to carry program code in the form of computer-executable instructions or data structures and which can be accessed by a general purpose or special purpose computer.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code.

Embodiments of the present disclosure can also be implemented in cloud computing environments. In this description, “cloud computing” is defined as a model for enabling on-demand network access to a shared pool of configurable computing resources. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth.

FIG. 10 illustrates, in block diagram form, an example computing device 1000 (e.g., the computing device 600, the client device(s) 110, and/or the server device(s) 102) that may be configured to perform one or more of the processes described above. As shown by FIG. 10, the computing device can comprise a processor(s) 1002, memory 1004, a storage device 1006, an I/O interface 1008, and a communication interface 1010.

In particular embodiments, processor(s) 1002 includes hardware for executing instructions, such as those making up a computer program. As an example, and not by way of limitation, to execute instructions, processor(s) 1002 may retrieve (or fetch) the instructions from an internal register, an internal cache, memory 1004, or a storage device 1006 and decode and execute them. The computing device 1000 includes memory 1004, which is coupled to the processor(s) 1002. The memory 1004 may be used for storing data, metadata, and programs for execution by the processor(s). The memory 1004 may include one or more of volatile and non-volatile memories. The memory 1004 may be internal or distributed memory. The computing device 1000 includes a storage device 1006 includes storage for storing data or instructions. As an example, and not by way of limitation, storage device 1006 can comprise a non-transitory storage medium described above. The computing device 1000 also includes one or more input or output (“I/O”) devices/interfaces 1008, which are provided to allow a user to provide input to (such as user strokes), receive output from, and otherwise transfer data to and from the computing device 1000. These I/O devices/interfaces 1008 may include a mouse, keypad or a keyboard, a touch screen, camera, optical scanner, network interface, modem, other known I/O devices or a combination of such I/O devices/interfaces 1008.

The computing device 1000 can further include a communication interface 1010. The communication interface 1010 can include hardware, software, or both. The communication interface 1010 can provide one or more interfaces for communication (such as, for example, packet-based communication) between the computing device and one or more other computing devices (e.g., computing device 1000) or one or more networks. The computing device 1000 can further include a bus 1012. The bus 1012 can comprise hardware, software, or both that couples components of computing device 1000 to each other.

What is claimed is:

1. A computer-implemented method comprising:
receiving, by at least one processing device, a text prompt and a digital image with a binary mask indicating a region of interest in the digital image; and
generating, utilizing a mask-aware vision-language captioning model, an image caption for the digital image describing the region of interest based on the text prompt.

2. The computer-implemented method of claim 1, further comprising:
generating, utilizing a mask-aware encoder of the mask-aware vision-language captioning model, a mask-aware feature map encoding features of the region of interest based on the binary mask and a lower-resolution version of the digital image; and
wherein generating, utilizing the mask-aware vision-language captioning model, the image caption for the digital image describing the region of interest based on the text prompt comprises generating from the mask-aware feature map and the text prompt, utilizing a large language model of the mask-aware vision-language captioning model, the image caption.

3. The computer-implemented method of claim 2, further comprising:
generating, utilizing a first higher-resolution encoder, a first high-resolution feature map encoding detailed spatial information of the digital image;
generating, utilizing a second higher-resolution encoder, a second high-resolution feature map encoding fine-grained features of the digital image; and
wherein generating, utilizing the mask-aware vision-language captioning model, the image caption for the digital image describing the region of interest based on the text prompt comprises generating from the mask-aware feature map, the first high-resolution feature map, the second high-resolution feature map, and the text prompt, utilizing the large language model of the mask-aware vision-language captioning model, the image caption.

4. The computer-implemented method of claim 2, wherein generating, utilizing the mask-aware encoder of the mask-aware vision-language captioning model, the mask-aware feature map encoding features of the region of interest based on the binary mask and the lower-resolution version of the digital image comprises:
generating, utilizing an image encoder neural network, a combined input sequence aligning a mask-referred region of the binary mask with a low-resolution version of the digital image; and
generating, utilizing the mask-aware encoder, the mask-aware feature map from the combined input sequence.

5. The computer-implemented method of claim 4, wherein generating, utilizing the image encoder neural network, the combined input sequence aligning the mask-referred region of the binary mask with the low-resolution version of the digital image comprises:
generating, utilizing a patch embedding layer of the image encoder neural network, patch embeddings from the low-resolution version of the digital image;
generating, utilizing a convolutional layer of the image encoder neural network, mask embeddings from the binary mask; and
generating the combined input sequence by combining the patch embeddings and the mask embeddings.

6. The computer-implemented method of claim 1, further comprising generating, utilizing a channel-wise fusion layer of the mask-aware vision-language captioning model, a fused feature map comprising unified features from a mask-aware feature map of the digital image, a first high-resolution feature map of the digital image, and a second high-resolution feature map of the digital image; and
wherein generating, utilizing the mask-aware vision-language captioning model, the image caption for the digital image describing the region of interest based on the text prompt comprises generating, utilizing a large language model of the mask-aware vision-language captioning model, the image caption based on the fused feature map.

7. The computer-implemented method of claim 6, wherein generating, utilizing the large language model of the mask-aware vision-language captioning model, the image caption based on the fused feature map comprises mapping the fused feature map into an embedding space of the large language model of the mask-aware vision-language captioning model.

8. A system comprising:
one or more memory devices; and
one or more processing devices configured to cause the system to:
receive a text prompt requesting a description of a digital image with reference to a region of interest;
access, by at least one processor, a binary mask indicating the region of interest within the digital image;
generate, utilizing a mask-aware encoder of a mask-aware vision-language captioning model, a mask-aware feature map encoding features of the region of interest based on the binary mask and a lower-resolution version of the digital image; and
generate from the mask-aware feature map and the text prompt, utilizing a large language model of the mask-aware vision-language captioning model, an image caption of the digital image with reference to the region of interest as requested in the text prompt.

9. The system of claim 8, wherein the one or more processing devices are further configured to generate, utilizing the mask-aware encoder of the mask-aware vision-language captioning model, the mask-aware feature map encoding features of the region of interest based on the binary mask and the lower-resolution version of the digital image by:
generating, utilizing a patch embedding layer of an image encoder network, patch embeddings from a low-resolution version of the digital image;
generating, utilizing a convolutional layer of an image encoder neural network, mask embeddings from the binary mask;
generating a combined input sequence by combining the patch embeddings and the mask embeddings; and
generating, utilizing the mask-aware encoder, the mask-aware feature map from the combined input sequence.

10. The system of claim 9, wherein generating the combined input sequence by combining the patch embeddings and the mask embeddings comprises:
removing spatial information from the patch embeddings and the mask embeddings; and
concatenating the patch embeddings and the mask embeddings together.

11. The system of claim 8, wherein the one or more processing devices are further configured to:
generate, utilizing one or more higher-resolution encoders, one or more high-resolution feature maps encoding at least one of detailed spatial information of the digital image or fine-grained features of the digital image; and
wherein the image caption of the digital image is further generated from the one or more high-resolution feature maps.

12. The system of claim 8, wherein the one or more processing devices are further configured to generate from the mask-aware feature map and the text prompt, utilizing the large language model of the mask-aware vision-language captioning model, the image caption of the digital image with reference to the region of interest as requested in the text prompt by:
generating, utilizing a channel-wise fusion layer of the mask-aware vision-language captioning model, a fused feature map comprising unified features from the mask-aware feature map of the digital image and one or more high-resolution feature maps of the digital image; and
mapping the fused feature map into an embedding space of the large language model of the mask-aware vision-language captioning model.

13. The system of claim 12, wherein generating, utilizing the channel-wise fusion layer of the mask-aware vision-language captioning model, the fused feature map comprising the unified features from the mask-aware feature map of the digital image and the one or more high-resolution feature maps of the digital image comprises:
modifying spatial dimensions of the mask-aware feature map to match spatial dimensions of the one or more high-resolution feature maps; and
concatenating the mask-aware feature map and the one or more high-resolution feature maps along a channel dimension of the channel-wise fusion layer.

14. The system of claim 13, wherein modifying the spatial dimensions of the mask-aware feature map to match the spatial dimensions of the one or more high-resolution feature maps comprises:
resizing the mask-aware feature map;
interpolating the resized mask-aware feature map to match the spatial dimensions of the one or more high-resolution feature maps; and
flattening the mask-aware feature map into a sequence for concatenation along the channel dimension of the channel-wise fusion layer.

15. The system of claim 8, wherein generating the image caption of the digital image with reference to the region of interest as requested in the text prompt comprises generating at least one of:
a regional dense caption describing the region of interest with respect to one or more additional regions of the digital image; or
a comprehensive global image caption describing the region of interest of the digital image within a global context of the digital image.

16. A non-transitory computer readable medium storing executable instructions which, when executed by a processing device, cause the processing device to perform operations comprising:
receiving a text prompt requesting a description of a digital image with reference to a region of interest;
generating, utilizing a mask-aware encoder of a mask-aware vision-language captioning model, a mask-aware feature map encoding features of the region of interest based on a lower-resolution version of the digital image and a binary mask indicating the region of interest within the lower-resolution version of the digital image;
generating, utilizing a first higher-resolution encoder, a first high-resolution feature map encoding detailed spatial information of the digital image;
generating, utilizing a second higher-resolution encoder, a second high-resolution feature map encoding fine-grained features of the digital image; and
generating from the mask-aware feature map, the first high-resolution feature map, the second high-resolution feature map, and the text prompt, utilizing a large language model of the mask-aware vision-language captioning model, an image caption of the digital image with reference to the region of interest as requested in the text prompt.

17. The non-transitory computer readable medium of claim 16, wherein the operations further comprise mapping, utilizing an adapter layer of the mask-aware vision-language captioning model, a fused feature map into an embedding space of the large language model, the fused feature map based on the mask-aware feature map, the first high-resolution feature map, and the second high-resolution feature map.

18. The non-transitory computer readable medium of claim 16, wherein the operations further comprise generating the image caption to include an attribute-aware regional caption describing details of the region of interest.

19. The non-transitory computer readable medium of claim 16, wherein generating the image caption of the digital image with reference to the region of interest as requested in the text prompt comprises generating the image caption to include a regional dense caption describing the region of interest with respect to one or more additional regions of the digital image.

20. The non-transitory computer readable medium of claim 16, wherein generating the image caption of the digital image with reference to the region of interest as requested in the text prompt comprises generating the image caption to include a comprehensive global image caption describing the region of interest of the digital image within a global context of the digital image.
